(19) United States
(12) Patent Application Publication
(10) Pub. No.: US 2026/0017367 A1
(43) Pub. Date: Jan. 15, 2026

(54) SYSTEMS AND METHODS FOR ARTIFICIAL INTELLIGENCE-BASED CYBERSECURITY THREAT INTELLIGENCE

(71) Applicant: Google LLC, Mountain View, CA (US)

(72) Inventors: Christopher Michael Galbraith, Philadelphia, PA (US); Scott Eric Coull, Cary, NC (US); Philip Joseph Tully, Potomac, MD (US); Nicholas Todd Smith, Santa Ana, CA (US)

(21) Appl. No.: 18/770,954

(22) Filed: Jul. 12, 2024

(51) Int. Cl. G06F 21/55; G06N 3/0475; G06N 3/088

(52) U.S. Cl. CPC G06F 21/552; G06N 3/0475; G06N 3/088

(57) ABSTRACT

A method includes generating, using an AI model, a first object embedding of a first threat intelligence (TI) data object that includes first one or more cybersecurity attributes of a business entity. The method includes obtaining one or more second object embeddings that each represents a respective second TI data object that includes second one or more cybersecurity attributes of a cybersecurity threat. The method includes, for each second object embedding, generating a respective similarity value reflecting a similarity between the first object embedding and the respective second object embedding. The method includes ranking, based on the similarity values, the one or more second TI data objects. The method includes identifying, based on the ranking, a subset of the one or more second TI data objects that are relevant to the first TI data object.

### TECHNICAL FIELD

The instant specification generally relates to computing devices. More specifically, the instant specification relates to artificial intelligence-based cybersecurity threat intelligence.

### BACKGROUND

Digital information systems are under constant risk by cybersecurity threats. Realization of these threats result in lost data, disrupted operations, and financial harm. As individuals' and entities' reliance on digital information systems grow, the need for innovative cybersecurity solutions to safeguard data and infrastructure also increases.

### SUMMARY

Disclosed herein are systems and methods for artificial intelligence (AI)-based cybersecurity threat intelligence. One aspect of the disclosure includes a method. The method includes generating, using an artificial intelligence (AI) model, a first object embedding of a first threat intelligence (TI) data object. The first TI data object may include first one or more cybersecurity attributes of an entity. The method includes obtaining one or more second object embeddings. Each second object embedding may include an object embedding that represents a respective second TI data object. The respective second TI data object may include second one or more cybersecurity attributes of a cybersecurity threat. The method includes, for each second object embedding, generating a respective similarity value reflecting a similarity between the first object embedding and the respective second object embedding. The method includes ranking, based on the similarity values, the one or more second TI data objects. The method includes identifying, based on the ranking, a subset of the one or more second TI data objects that are relevant to the first TI data object. The entity corresponding to the first TI data object can be a business entity, a cybersecurity threat, or some other type of entity.

Another aspect of the disclosure includes a system. The system includes a memory and a processing device coupled to the memory and configured to perform one or more operations. The operations include generating, using an AI model, a first object embedding of a first TI data object. The first TI data object may include first one or more cybersecurity attributes of an entity. The operations include obtaining one or more second object embeddings. Each second object embedding may include an object embedding that represents a respective second TI data object. The respective second TI data object may include second one or more cybersecurity attributes of a cybersecurity threat. The operations include, for each second object embedding, generating a respective similarity value reflecting a similarity between the first object embedding and the respective second object embedding. The operations include ranking, based on the similarity values, the one or more second TI data objects. The operations include identifying, based on the ranking, a subset of the one or more second TI data objects that are relevant to the first TI data object. The entity corresponding to the first TI data object can be a business entity, a cybersecurity threat, or some other type of entity.

Another aspect of the disclosure includes a non-transitory computer-readable storage medium that includes instructions that, when executed by a processing device, cause the processing device to perform one or more operations. The operations include generating, using an AI model, a first object embedding of a first TI data object. The first TI data object may include first one or more cybersecurity attributes of an entity. The operations include obtaining one or more second object embeddings. Each second object embedding may include an object embedding that represents a respective second TI data object. The respective second TI data object may include second one or more cybersecurity attributes of a cybersecurity threat. The operations include, for each second object embedding, generating a respective similarity value reflecting a similarity between the first object embedding and the respective second object embedding. The operations include ranking, based on the similarity values, the one or more second TI data objects. The operations include identifying, based on the ranking, a subset of the one or more second TI data objects that are relevant to the first TI data object. The entity corresponding to the first TI data object can be a business entity, a cybersecurity threat, or some other type of entity.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a schematic block diagram illustrating an example system for artificial intelligence (AI)-based cybersecurity threat intelligence, in accordance with some implementations of the present disclosure.

FIG. 2 is a schematic block diagram illustrating an example AI subsystem for AI-based cybersecurity threat intelligence, in accordance with some implementations of the present disclosure.

FIG. 3 is a flowchart illustrating an example method for practicing selected aspects of the present disclosure, in accordance with some implementations of the present disclosure.

FIG. 4 is a schematic diagram illustrating an example threat intelligence data object, in accordance with some implementations of the present disclosure.

FIG. 5 is a schematic block diagram illustrating an example AI model for AI-based cybersecurity threat intelligence, in accordance with some implementations of the present disclosure.

FIG. 6 is a schematic block diagram illustrating an example dataflow for AI-based cybersecurity threat intelligence, in accordance with some implementations of the present disclosure.

FIG. 7 is a schematic block diagram illustrating another example dataflow for AI-based cybersecurity threat intelligence, in accordance with some implementations of the present disclosure.

FIG. 8 depicts a block diagram of an example computer device capable of AI-based cybersecurity threat intelligence, in accordance with some implementations of the present disclosure.

### DETAILED DESCRIPTION

Every day, entities around the world face thousands of potential cybersecurity threats spanning a wide variety of contexts. However, not every cybersecurity threat is relevant to every entity. A cybersecurity threat may be relevant to an entity if the entity is at risk of being harmed by the cybersecurity threat or if the entity knowing more about the cybersecurity threat would improve the cybersecurity of the entity. For example, where the cybersecurity threat is a vulnerability of a first type of operating system (OS), the cybersecurity threat may not be relevant to an entity that does not use the first type of OS. In another example, where the cybersecurity threat is a cyberattack campaign focused on a certain country, the cybersecurity threat is likely not relevant to entities in a different country. Thus, because of limited resources, an entity's cybersecurity team often focuses on cybersecurity threats relevant to that entity.

However, conventional cybersecurity threat intelligence (TI) offerings include many shortcomings. Some offerings are limited in scope, providing information about only a small portion of cybersecurity threats. For example, a vulnerability database may provide information about computer vulnerabilities, but may not offer information about other types of cybersecurity threats. Other TI offerings provide a one-size-fits-all database that may include cybersecurity threat information irrelevant to a cybersecurity team's interests. Even when such TI offerings include filtering capabilities, the filtered results often still result in too much information for a cybersecurity team to evaluate and use. These conventional cybersecurity TI offerings, thus, result in a degraded user experience and missed pertinent threats.

Aspects and implementations of the present disclosure address the above deficiencies, among others, by providing a security platform that utilizes artificial intelligence (AI) to identify cybersecurity entities (e.g., threat actors, cybersecurity vulnerabilities, malware families, cyberattack campaigns, cybersecurity reports, or other cybersecurity-related entities) that are relevant to another entity (sometimes referred to as a “target entity”). The target entity may include a business entity using the security platform, or the entity may include another type of entity (e.g., another cybersecurity entity). The identified cybersecurity entities may be relevant to the target entity because they are conceptually similar, which can be measured in a variety of ways including attribute similarity of, shared relationships between, and expert knowledge linking the target entity and the identified cybersecurity entities may be similar. As an example, where the target entity is a business entity, the identified cybersecurity entities may be relevant to the business entity because the business entity may be at risk from the identified cybersecurity entities, or information about the identified cybersecurity entities may assist the business entity in guarding against cybersecurity threats. The business entity may then access information about the identified cybersecurity entities in order to perform actions to protect the business entity.

The security platform can use an AI model to generate object embeddings that represent an entity (e.g., a business entity or a cybersecurity entity) in an embedding space. An embedding may include a numerical vector that encodes higher-dimensional data of the corresponding entity into a lower-dimensional form that can be compared with other embeddings. The security platform may compare object embeddings to determine whether object embeddings are similar. An embedding corresponding to a cybersecurity entity that is similar to the embedding corresponding to the target entity may indicate that the cybersecurity entity is relevant to the target entity.

The security platform can cause display of a user interface of the security platform. The user interface may provide a list of one or more of the cybersecurity entities that are relevant to the target entity. In response to a user interacting with an item on the list of cybersecurity entities, the security platform may display information about the cybersecurity entity corresponding to the item. For example, responsive to the user interacting with an item corresponding to a threat actor, the TI user interface may display information about the threat actor. Responsive to the user interacting with an item corresponding to a cybersecurity report, the TI user interface may display the report for the user to read. In one example, where the target entity is a business entity, the user may then use the information from the TI user interface to protect the business entity from cybersecurity threats identified by the TI user interface or to otherwise protect the business entity from cybersecurity risks.

Aspects and implementations of the present disclosure overcome the deficiencies of conventional cybersecurity TI offerings by using AI to identify cybersecurity entities that pose a risk to a business entity or to identify cybersecurity entities that provide information that may assist the business entity in guarding against cybersecurity threats. By using AI to identify the cybersecurity entities, (1) fewer resources are expended to identify cybersecurity entities that are relevant to a target entity, and (2) the time it takes for a business entity's security team (whether measured in actual time or people-hours) to identify and investigate relevant threats is reduced, which enables the security team to investigate more and higher priority cybersecurity threats with fewer expended resources. Furthermore, the security platform (or other cybersecurity services) can use the AI model-generated object embeddings to perform additional cybersecurity analysis-related functions in a wide variety of contexts. For example, the security platform can use the object embeddings as input to other AI models that classify cybersecurity entities or events such that the classifications can be used in other cybersecurity operations. Furthermore, the security platform can use the object embeddings to perform clustering operations on cybersecurity entities for discovery, visualization, or other purposes. Also, the security platform can use similarity values derived from comparisons of the object embeddings (discussed below) to provide scores or metrics personalized to a business entity that can indicate relevance to that entity. This relevance score can be combined with scores derived from other sources that indicate the severity (e.g., a potential impact) a cybersecurity threat may pose to the business entity and the confidence in that severity. The combination of relevance, severity, and confident scores can result in improved business entity-specific cybersecurity outcomes.

In addition, some benefits of the present disclosure may provide a technical effect caused by or resulting from a technical solution to a technical problem. For example, one technical problem may relate to quickly and accurately identifying cybersecurity threats that are relevant to a target entity-whether the target entity is a business entity or another cybersecurity threat-so that the identified cybersecurity threats can be responded to or remediated. One of the technical solutions to the technical problem may include using AI to identify relevant cybersecurity entities. As a consequence, the irrelevant or inaccurate information presented to the security team regarding cybersecurity threats is reduced or eliminated. Using AI models of the present disclosure can identify relationships between cybersecurity threats even when the relationships may not explicitly exist in the data included in TI data objects. For example, the target entity may include a newly discovered cybersecurity vulnerability, and the AI models of the present disclosure may identify one or more threat actors as relevant to the new vulnerability, even when such a relationship has not explicitly been discovered.

Another technical problem can relate to a security team's high usage of network bandwidth when attempting to identify cybersecurity entities that are relevant to their organization (e.g., by having to access many websites, databases, and the like in order to find information about relevant cybersecurity entities). One of the technical solutions to the technical problem may include using AI to identify relevant cybersecurity entities. As a consequence, the security team's network bandwidth usage is reduced (e.g., because they do not have to access the large variety of websites, databases, etc.).

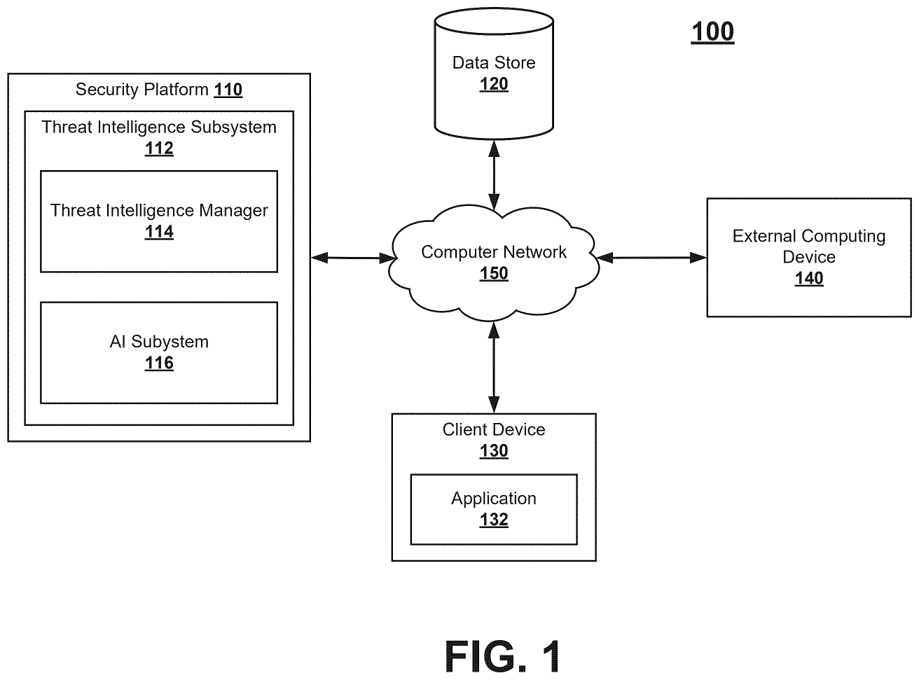

FIG. 1 depicts an example system for artificial intelligence AI-based cybersecurity threat intelligence, in accordance with some implementations of the present disclosure. The system 100 may include a system for AI-based cybersecurity threat intelligence. In one implementation, the system 100 includes a security platform 110, a data store 120, a client device 130, or an external computing device 140. The security platform 110 may include a TI subsystem 112, which may include a TI manager 114 or an AI subsystem 116. The client device 130 may include an application 132. The security platform 110, the data store 120, the client device 130, or the external computing device 140 may be in data communication over a computer network 150.

In one implementation, the security platform 110 may include one or more computing devices. A computing device may include a physical computing device or may include a virtualized component, such as a virtual machine (VM) or a container. A computing device may include an instance of a computing device. An instance of a computing device may include a spun-up instance that may not be specific to any computing device. In some implementations, a VM may include a system virtual machine, which may include a VM that emulates an entire physical computing device. A VM can include a process virtual machine, which may include a VM that emulates an application or some other software. A container may include a computing environment that logically surrounds one or more software applications independently of other applications executing in the cloud computing environment.

In some implementations, the security platform 110 includes a cloud computing system. A cloud computing system may include one or more computing devices (or portions of cloud computing devices) provided to an end user by a cloud provider. An end user of the environment may utilize a portion of the cloud computing system to host content for use or access by other parties or perform other computational tasks. In some implementations, the cloud computing system may be configured to allow the end user to use a portion of a computing device (e.g., only certain hardware, software, or other computer system resources). The cloud computing environment may include a private cloud, a public cloud, or a hybrid cloud. The cloud computing environment may provide infrastructure-as-a-service (IaaS), platform-as-a-service (PaaS), or software-as-a-service (SaaS) computing. The cloud computing environment may provide serverless computing.

In implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the TI subsystem 112 collects user information (e.g., information about a user's social network, social actions or activities, profession, a user's preferences, or a user's current location), or to control whether and/or how to receive content from the TI subsystem 112 in that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the TI subsystem 112.

In some implementations, the security platform 110 provides computer security functionality to one or more computing devices or cloud computing systems (or portions thereof) operated by a user (which, as discussed above, may include an entity). For example, the computing devices or cloud computing systems may provide computing systems, storage systems, communication systems (e.g., email, video conferencing, etc.) for the user, and the security platform 110 may provide security functions related to securing such systems. The security platform 110 may include various security subsystems such as an identity and access management (IAM) subsystem for managing user identities and permissions on the computing devices or cloud computing systems, a data loss prevention (DLP) subsystem for automatically classifying and securing sensitive data stored by the computing devices or cloud computing systems, or the TI subsystem 112 for identifying relevant cybersecurity entities.

In one or more implementations, the TI subsystem 112 includes software or hardware configured to identify cybersecurity entities that are relevant to a first entity. The first entity may include the business entity to which the user of the security platform 110 belongs. The TI subsystem 112 may include the TI manager 114 and the AI subsystem 116. The TI manager 114 may generate, store, and manage data about various cybersecurity entities. The TI manager 114 may receive input from a user and perform various TI operations based on the input. The TI manager 114 may use the AI subsystem 116 to determine whether a first entity is relevant to a second entity, as discussed herein. The AI subsystem 116 may include one or more AI models or AI models that the TI manager 114 may use to determine whether a first entity is relevant to a second entity.

In some implementations, the data store 120 stores data used by the TI subsystem 112. The data may include TI data objects that correspond to cybersecurity entities. The data store 120 may include a physical storage medium that can include volatile storage (e.g., random access memory (RAM), etc.) or non-volatile storage (e.g., a hard disk drive (HDD), flash memory, etc.). The data store 120 can include a file system, a database, or some other software configured to store data.

In one implementation, the client device 130 includes a computing device. A user of the security platform 110 may use the client device 130 to interact with the security platform 110, including the TI subsystem 112. In some implementations, the client device 130 includes an application 132, which can be a desktop application, a web browser, a mobile application, etc. The application 132 can present, on a display device of the client device 130, a TI user interface. The TI user interface may display one or more visualizations based on data received from the TI subsystem 112 (e.g., a visualization of a TI data object, as discussed below). The client device 130 may include one or more user input devices by which the user of the client device 130 may provide user input to the application 132, and the application 132 may provide data to the TI subsystem 112 based on the user input.

In some implementations, the external computing device 140 may include a computing device that is external from the security platform 110 (e.g., the external computing device 140 may not be controlled or operated by an entity that operates the security platform 110). The external computing device 140 may store data that the TI subsystem 112 may use. For example, the external computing device 140 may store a cybersecurity report. The TI subsystem 112 may access the data over the computer network 150.

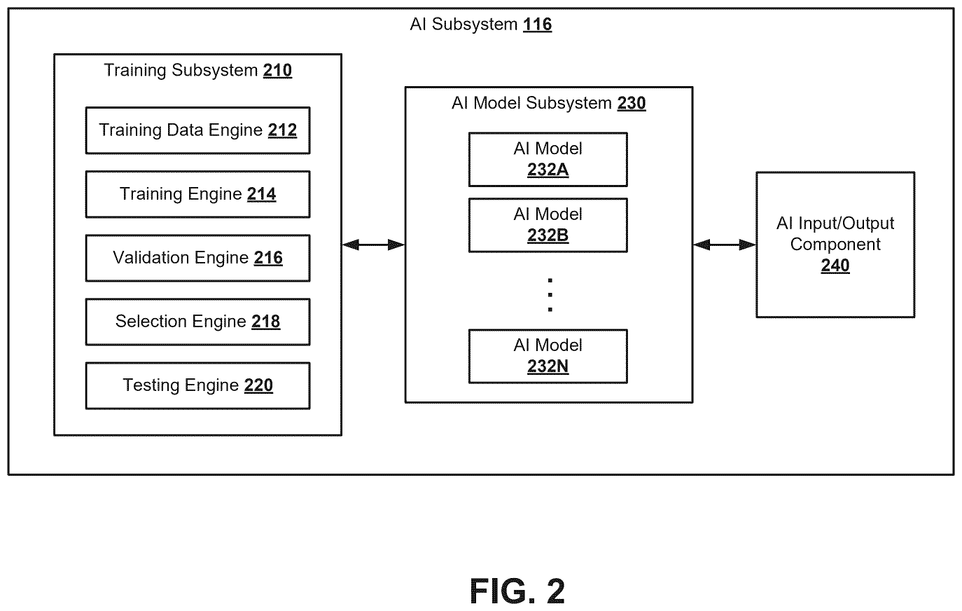

FIG. 2 depicts an example AI subsystem 116 for AI-based cybersecurity threat intelligence, in accordance with some implementations of the present disclosure. As illustrated in FIG. 2, the AI subsystem 116 can include a training subsystem 210, which may include a training data engine 212, a training engine 214, a validation engine 216, a selection engine 218, or a testing engine 220. The AI subsystem 116 may include an AI model subsystem 230, which may include one or more AI models 232A-N. The AI subsystem 116 may include an AI input/output component 240.

In one implementation, an AI model 232A-N includes one or more of artificial neural networks (ANNs), decision trees, random forests, support vector machines (SVMs), clustering-based models, Bayesian networks, or other types of machine learning models. An ANN may include a feature representation component with a classifier or regression layers that map features to a target output space. An ANN may implement a metric learning approach that maps features to an embedding space. The metric learning approach may include an AI learning or training process configured to train AI models to (1) maximize a similarity metric (e.g., minimizing a distance in an embedding space) for inputs that are similar, and (2) minimize a similarity metric for inputs that are dissimilar.

An ANN can include multiple nodes (“neurons”) arranged in one or more layers, and a neuron may be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification), unsupervised (e.g., pattern analysis), self-supervised, or metric learning manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, an AI model 232A-N includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), a large language model (LLM), or a diffusion model. In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some implementations, an AI model 232A-N is an AI model that has been trained on a corpus of data. For example, the AI model 232A-N can be an AI model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 232A-N to learn broad elements including, image or speech recognition, general sentence structure, common phrases, vocabulary, natural language structure, and other elements. In some implementations, this first foundational model is trained using self-supervision, or unsupervised training on such datasets.

In some implementations, the second portion of training, including fine-tuning, includes unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 232A-N while training may be ranked by a user, according to a variety of factors, including accuracy, helpfulness, veracity, acceptability, or any other metric useful in the fine-tuning portion of training. In this manner, the AI model 232A-N can learn to favor these and any other factors relevant to users when generating a response. Further details regarding training are provided below.

In some implementations, an AI model 232A-N includes one or more pre-trained models, or fine-tuned models. In a non-limiting example, in some implementations, the goal of the “fine-tuning” can be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one implementation, the training subsystem 210 manages the training and testing of an AI model 232A-N. The training data engine 212 can generate training data. For example, in the present disclosure the training data may include TI data objects, embeddings based on TI data objects, or other data based on TI data objects. The training engine 214 may use the training data to train a generative AI model 232A-N configured to generate an object embedding or an intermediate embedding, as discussed below.

In an illustrative example, the training data engine 212 can initialize a training set T to null (e.g., { }). The training data engine 212 can add the training data to the training set T and can determine whether training set T is sufficient for training a AI model 232A-N. The training set T can be sufficient for training the AI model 232A-N if the training set T includes a threshold amount of training data, in some implementations. In response to determining that the training set T is not sufficient for training, the training data engine 212 can identify additional data to use as training data. In response to determining that the training set T is sufficient for training, the training data engine 212 can provide the training set T to the training engine 214.

The training engine 214 can train an AI model 232A-N using the training data (e.g., training set T). The AI model 232A-N may refer to the model artifact that is created by the training engine 214 using the training data, where such training data can include training inputs and, in some implementations, corresponding target outputs. The training engine 214 can input the training data into the AI model 232A-N so that the AI model 232A-N can find patterns in the training data and configure itself based on those patterns.

Where the AI model 232A-N uses supervised learning, the training engine 214 can assist the AI model 232A-N in determining whether the AI model 232A-N maps the training input to the target output. Where the AI model 232A-N uses unsupervised learning, the training engine 214 can input the training data into the AI model 232A-N The AI model 232A-N can configure itself based on the input training data, but since the training data may not include a target output, the training engine 214 may not assist the AI model 232A-N in determining whether the AI model 232A-N provided a correct output during the training process. Further details regarding training data and the training process implemented by the training engine 214 are discussed further below.

The validation engine 216 may be capable of validating a trained AI model 232A-N using a corresponding set of features of a validation set from the training data engine 212. The validation engine 216 can determine an accuracy of each of the trained AI models 232A-N based on the corresponding sets of features of the validation set. Where the training data may not include a target output, validating a trained AI model 232A-N may include obtaining an output from the AI model 232A-N and providing the output to another entity for evaluation. The other entity may include another AI model configured to evaluate the output of the AI model 232A-N that is undergoing training. The other entity may include a human. The validation engine 216 can discard a trained AI model 232A-N that has an accuracy that does not meet a threshold accuracy or that otherwise fails evaluation. In some implementations, the selection engine 218 is capable of selecting a trained AI model 232A-N that has an accuracy that meets a threshold accuracy. In some implementations, the selection engine 218 may be capable of selecting the trained AI model 232A-N that has the highest accuracy of multiple trained AI models 232A-N. In some implementations, the selection engine 218 receives input from another AI model or a human and can select a trained AI model 232A-N based on the input.

The testing engine 220 may be capable of testing a trained AI model 232A-N using a corresponding set of features of a testing set from the training data engine 212. For example, a first trained AI model 230A that was trained using a first set of features of the training set may be tested using the first set of features of the testing set. The testing engine 220 can determine a trained AI model 232A-N that has the highest accuracy or other evaluation of all of the trained AI models 232A-N based on the testing sets.

The AI model subsystem 230 may be capable of managing the one or more AI models 232A-N. Managing the one or more AI models 232A-N may include providing access to an AI model 232A-N by the training subsystem 210 so the training subsystem 210 can train the AI model 232A-N. Managing the one or more AI models 232A-N may include obtaining an input from the AI input/output component 240, executing an AI model 232A-N on the input, obtaining the output from the AI model 232A-N, and providing the output to the AI input/output component 240. Managing the one or more AI models 232A-N may include selecting one or more AI models 232A-N for use.

In some implementations, the AI subsystem 116 includes AI input/output component 240. The AI input/output component 240 can be configured to feed data as input to an AI model 232A-N. The input may include a TI data object (or a portion thereof), an intermediate embedding, or other data from the TI manager 114. The AI input/output component 240 can be configured to obtain one or more outputs from the one or more AI models 232A-N and provide the one or more outputs to the TI manager 114.

As indicated above, in some embodiments, an AI model 232A-N includes an LLM. In some embodiments, the LLM includes generative AI functionality. The LLM may include a transformer. The AI model 232A-N can generate new content based on provided input data (e.g., an object embedding). The generative AI model 232A-N can be supported by a prompt subsystem (not shown), which may reside on the system 100. The prompt subsystem can enable a user or a component of the system 100 to access the generative AI model 232A-N. The prompt subsystem can be configured to perform automated identification of, and facilitate retrieval of, relevant and timely contextual information for efficient and accurate processing of prompts by the AI model 232A-N. Using the computer network 150 (or another network), the prompt subsystem may be in communication with one or more of the TI manager 114, the AI subsystem 116, or the application 132. Communications between the prompt subsystem and the AI input/output component 240 can be facilitated by a generative model application programming interface (API), in some embodiments. Communications between the prompt subsystem and the TI manager 114, the AI subsystem 116, or the application 132 can be facilitated by a data management API. In additional or alternative embodiments, the generative model API translates prompts generated by the prompt subsystem into an unstructured natural-language format and, conversely, translates responses received from the AI model 232A-N into any suitable form (e.g., including any structured proprietary format as may be used by the prompt subsystem). Similarly, the data management API can support instructions that may be used to communicate data requests to the TI manager 114, the AI subsystem 116, or the application 132 and formats of data received from such components.

The prompt subsystem may include (or may have access to) instructions stored on one or more tangible, machine-readable storage media of a computing device (e.g., the security platform 110) and executable by one or more processing devices of the computing device. In one embodiment, the prompt subsystem can be implemented on a single machine. In some embodiments, the prompt subsystem may be a combination of a client component and a server component. Alternatively, some portion of the prompt subsystem may be executed on a client computing device while another portion of the query tool may be executed on a server machine.

In some implementations, the training subsystem 210 is part of the security platform 110, the TI subsystem 112, or the TI manager 114. Alternatively, the training subsystem 210 may be part of another platform, server, system, subsystem, or it may be an independent system. In some implementations, the training subsystem 210 provides the trained one or more AI models 232A-N to the AI model subsystem 230.

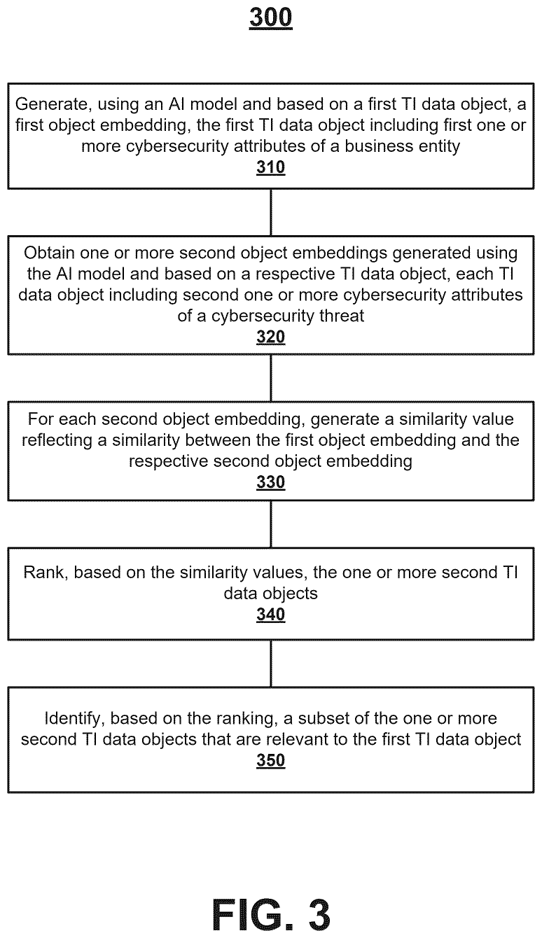

FIG. 3 depicts an example method 300 for AI-based cybersecurity threat intelligence, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 300 and/or one or more of the method's 300 individual functions, routines, subroutines, or operations. In certain implementations, a single processing thread can perform the method 300. Alternatively, two or more processing threads can perform the method 300, each thread executing one or more individual functions, routines, subroutines, or operations of the method. In an illustrative example, the processing threads implementing the method 300 can be synchronized (e.g., using semaphores, critical sections, and/or other thread synchronization mechanisms). Alternatively, the processing threads implementing the method 300 can be executed asynchronously with respect to each other. Various operations of the method 300 can be performed in a different (e.g., reversed) order compared with the order shown in FIG. 3. Some operations of the method 300 can be performed concurrently with other operations. Some operations can be optional. The TI manager 114 may perform one or more of the operations of the method 300.

At block 310, processing logic generates, using an AI model, a first object embedding of a first TI data object. The first TI data object may include first one or more cybersecurity attributes of an entity. The first TI data object may include a TI data object that represents a business entity. The business entity may include a customer or subscriber of the security platform 110.

A TI data object may include a data object that represents a business entity, a cybersecurity entity, or some other cybersecurity related entity. A TI data object may include data indicating one or more cybersecurity attributes of the corresponding entity. A cybersecurity attribute of an entity may include cybersecurity-related information about the entity. A cybersecurity attribute may include a key-value pair. Further information regarding cybersecurity attributes is provided below.

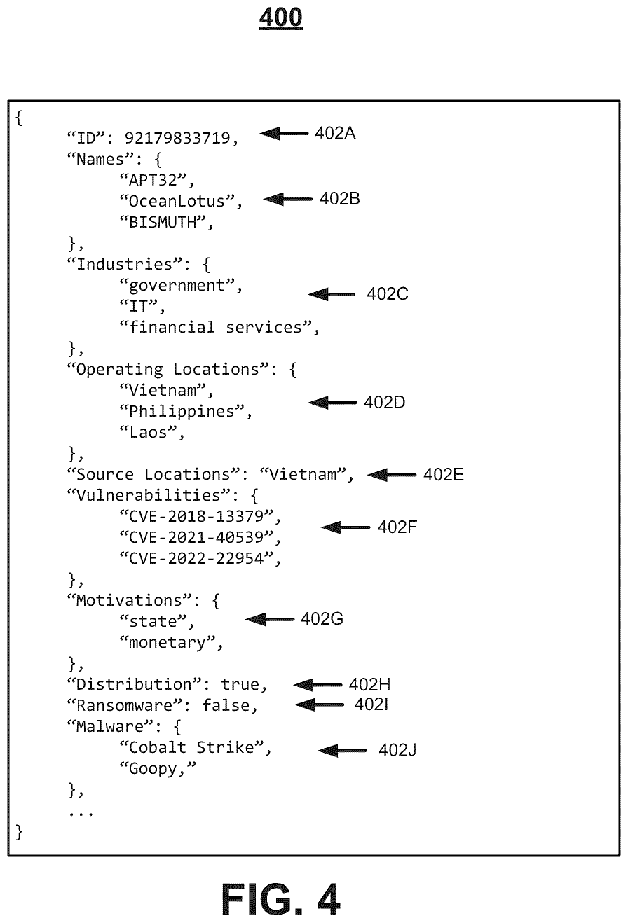

In some implementations, the TI subsystem 112 may generate TI data objects and may store the TI data objects in the data store 120. The TI subsystem 112 may obtain data indicating one or more cybersecurity attributes of a cybersecurity entity or a business entity, organize the data, and may generate a TI data object representing the cybersecurity entity or business entity. The TI subsystem 112 may obtain the data from a user inputting the data into the TI subsystem 112. The TI subsystem 112 may obtain the data from an external computing device 140. An example of a TI data object is depicted in FIG. 4 and explained below.

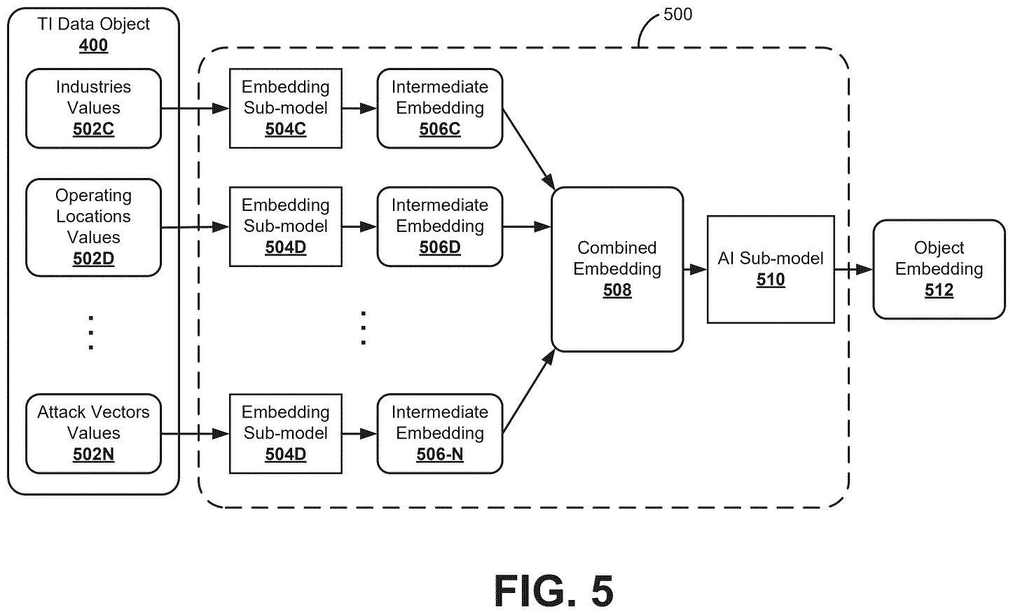

In one implementation, the AI model includes the AI model 500 discussed below in relation to FIG. 5. The entity may include a business entity. The entity may include a threat actor, a cybersecurity vulnerability, a piece of malware, a cyberattack campaign, a cybersecurity alert, a cybersecurity report, or some other cybersecurity-related entity. The first TI data object may correspond to the entity and may include one or more cybersecurity attributes of the entity. The first object embedding may include an embedding that represents the entity in an embedding space.

In some implementations, a business entity may include an individual person, a sole proprietorship, a partnership, a limited liability company, a corporation, or some other business entity. A threat actor may include a person or group of people that cause harm to a computer system, including advanced persistent threats (APTs), cyber criminals, nation-state actors, or the like. A cybersecurity vulnerability may include a flaw in a computing device that weakens the security of the computing device. A cybersecurity vulnerability may include a hardware vulnerability, software vulnerability, or the like. A piece of malware may include software that causes disruption to a computing device, provides unauthorized access to the device, deprives access to the device, or otherwise negatively impacts the device. A malware family may include a virus, worm, Trojan horse, ransomware, spyware, adware, keylogger, or the like. A cyberattack campaign may include a collection of actions taken by threat actors that are similar. A cybersecurity alert may include a statement, advisory, or some other publication that provides information about a cybersecurity threat. A cybersecurity report may include a report on one or more threat actors, cybersecurity vulnerabilities, malware families, cyberattack campaigns, cybersecurity incidents, cybersecurity alerts, or some other cybersecurity-related entity. A cybersecurity report may include information provided by cybersecurity experts or other cybersecurity personnel or organizations.

In some implementations, a cybersecurity attribute of an entity includes cybersecurity-related information about the entity. For example, a cybersecurity attribute may include one or more names of the entity. A name may include a name that the entity has given itself or a name given to it by personnel and entities in the field of cybersecurity. A cybersecurity attribute may include one or more industries associated with the entity. Where the entity is a threat actor, piece of malware, or a cybersecurity campaign, an industry may include an organizational sector that the entity may target. Where the entity is a business entity, an industry may include an organizational structure in which the business entity operates. An industry may include government, non-profit, education, agriculture, resource extraction, manufacturing, retail, transportation, communications services (e.g., telecommunications, broadcasting, digital communications, etc.), financial services (e.g., banking, investing, insurance, etc.), business services (e.g., accounting, consulting, information technology (IT), legal services, etc.), healthcare, or the like.

A cybersecurity attribute may include one or more operating locations of the entity. An operating location may include a world region (e.g., “Southeast Asia”), a country, an administrative division (e.g., a state, province, county, municipality, etc.), or some other location. For a threat actor, piece of malware, or a cybersecurity campaign, an operating location may include a location that the entity targets. For a business entity, an operating location may include a location where the business entity operates. A cybersecurity attribute may include one or more source locations of the entity. For a threat actor, piece of malware, or a cybersecurity campaign, a source location may include a location from which the entity operates, originates, or the like.

A cybersecurity attribute can identify one or more cybersecurity vulnerabilities. For a threat actor, piece of malware, or a cybersecurity campaign, a cybersecurity vulnerability may include a vulnerability that the entity exploits. For a business entity, a cybersecurity attribute may identify a cybersecurity vulnerability to which the business entity may be susceptible. A cybersecurity attribute can identify one or more motivations. For a threat actor, piece of malware, or a cybersecurity campaign, a motivation may include a reason why the entity operates. For example, a nation-state motivation may include aiding or harming a government organization (e.g., via espionage, disruption, etc.). A monetary motivation may include attempting to obtain money or other items of value. A political motivation may include attempting to achieve a political goal (e.g., bringing about a change in law, influencing an election, etc.). A business motivation may include aiding or harming a business organization. A recreational motivation may include a desire to exploit vulnerabilities for personal satisfaction.

A cybersecurity attribute may identify an indication as to whether the entity utilizes a wide distribution approach to achieve its goals. A wide distribution approach may include: attempting to target a large number of users, business entities, or other targets; using many different types of cybersecurity attacks or exploiting many different vulnerabilities; or other methods or actions that are designed to reach a wide variety of targets. In contrast, a narrow distribution approach may include: attempting to target specific users, business entities, or other targets; using specific cybersecurity attacks or exploiting specific vulnerabilities; or using other methods or actions that are designed to target a small number of specific targets. A cybersecurity attribute may identify an indication as to whether the entity utilizes ransomware. A cybersecurity attribute may identify one or more malware families. For a threat actor, piece of malware, or a cybersecurity campaign, a piece of malware identified by a cybersecurity attribute may include malware that the entity has used or is suspected to have used. For a business entity, a piece of malware identified by a cybersecurity attribute may include malware to which the business entity may be susceptible, malware about which the business entity is concerned, or the like. A cybersecurity attribute may identify tactics, techniques, and procedures (TTPs). For a threat actor, piece of malware, or a cybersecurity campaign, a TTP may include a TTP that the entity utilizes. For a business entity, a TTP may include a TTP that may be used on the business entity or about which the business entity may be concerned. A TTP may include using malware, using a denial-of-service (DOS) attack or distributed DoS (DDos) attack, social engineering, physical intrusion, or the like. A cybersecurity attribute may identify attack surface information. An attack surface may include a possible point where an unauthorized user may enter a computing device. An attack surface may include a specific piece of software or software, an operating system, or the like. An attack surface may include a specific version of a piece of software, operating system, or the like. An attack surface cybersecurity attribute may indicate that a certain piece of software, operating system, or the like is susceptible to a certain cybersecurity vulnerability.

In one implementation, using the AI model based on the first TI data object may include, for each cybersecurity attribute of the first one or more cybersecurity attributes, (1) generating, using an embedding sub-model, an intermediate embedding, (2) combining the intermediate embeddings, and (3) generating, using a trained AI sub-model and based on the combined intermediate embeddings, the first object embedding. Further details regarding this process are discussed further below in relation to FIG. 5.

In one implementation, block 310 includes the TI subsystem 112 obtaining information for the TI subsystem 112 to generate the first TI data object. As discussed above, the first TI data object may include a TI data object that represents a business entity. For example, the application 132 on the client device 130 may provide a UI on the client device 130 where a user that belongs to the business entity can input information about an entity, and the application 132 can provide the input information to the TI manager 114. The TI manager 114 can generate the first TI data object, with its respective cybersecurity attributes, based on the input information. The TI manager 114 may provide the first TI data object to the data store 120 for storage.

At block 320, processing logic obtains one or more second object embeddings. Each second object embedding may include an object embedding generated using the AI model. Each second object embedding may represent a respective second TI data object. The respective second TI data object may include second one or more cybersecurity attributes of a cybersecurity threat. Each second TI data object may represent a cybersecurity threat.

In some implementations, as discussed above, a TI data object (including a second TI data object) may include one or more cybersecurity attributes that identify information about the cybersecurity entity that the TI data object represents. Also as discussed above, the TI subsystem 112 may have previously received, generated, or otherwise obtained one or more second TI data objects (e.g. responsive to obtaining data about the corresponding cybersecurity entity from a user inputting the data into the TI subsystem 112 or the TI subsystem 112 obtaining the data about the cybersecurity entity from an external computing device 140. Generating a second object embedding based on a second TI data object may include using an AI model (e.g., the same AI model used to generate the first object embedding of the first TI data object of block 310) to generate the second object embedding based on the second TI data object. Using the AI model may include, for each cybersecurity attribute of the second one or more cybersecurity attributes of the second TI data object, (1) generating, using an embedding sub-model, an intermediate embedding, (2) combining the intermediate embeddings, and (3) generating, using a trained AI sub-model and based on the combined intermediate embeddings, the second object embedding. Further details regarding this process are discussed further below in relation to FIG. 5.

In some implementations, one or more second object embeddings may be stored in an embedding store of the data store 120. An embedding store may include a data store that stores a corpus of embeddings. The embedding store may include metadata (e.g., indices) configured to assist in quickly and efficiently storing and retrieving object embeddings. Obtaining the one or more second object embeddings in block 320 may include retrieving the one or more second object embeddings from the data store 120.

At block 330, for each second object embedding, processing logic generates a respective similarity value. Generating a similarity value may include using an operation, algorithm, or the like that uses multiple object embeddings as input and outputs a value that indicates a degree of similarity between the input object embeddings. Generating the similarity value may include using a distance function that calculates a distance between the input object embeddings in an embedding space. The distance function can calculate a Euclidean distance, a cosine distance (sometimes referred to as a “cosine similarity”), or some other type of distance between a first object embedding and a second object embedding. A cosine distance may include a measure of similarity between two vectors.

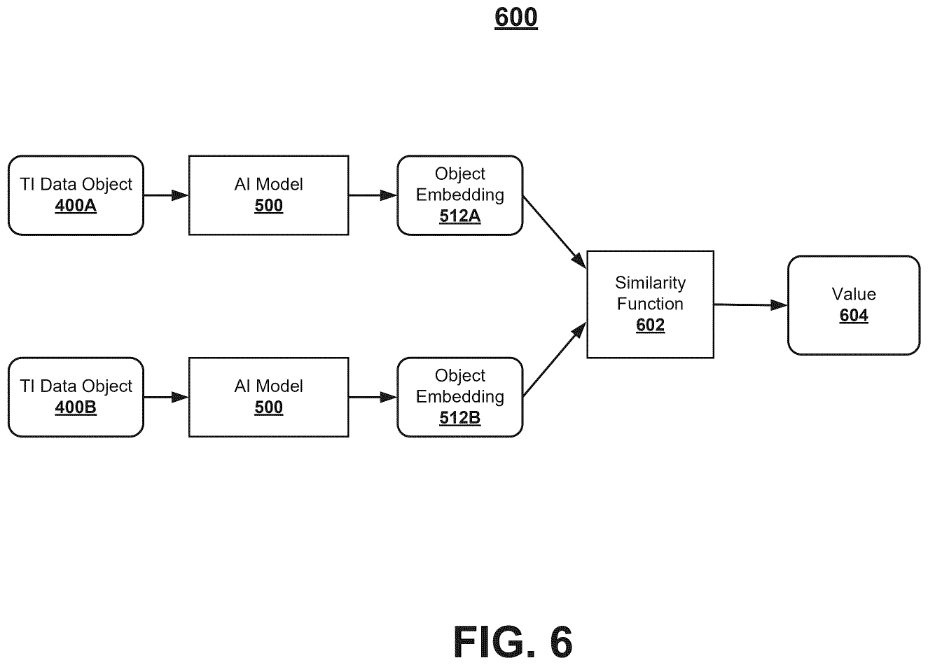

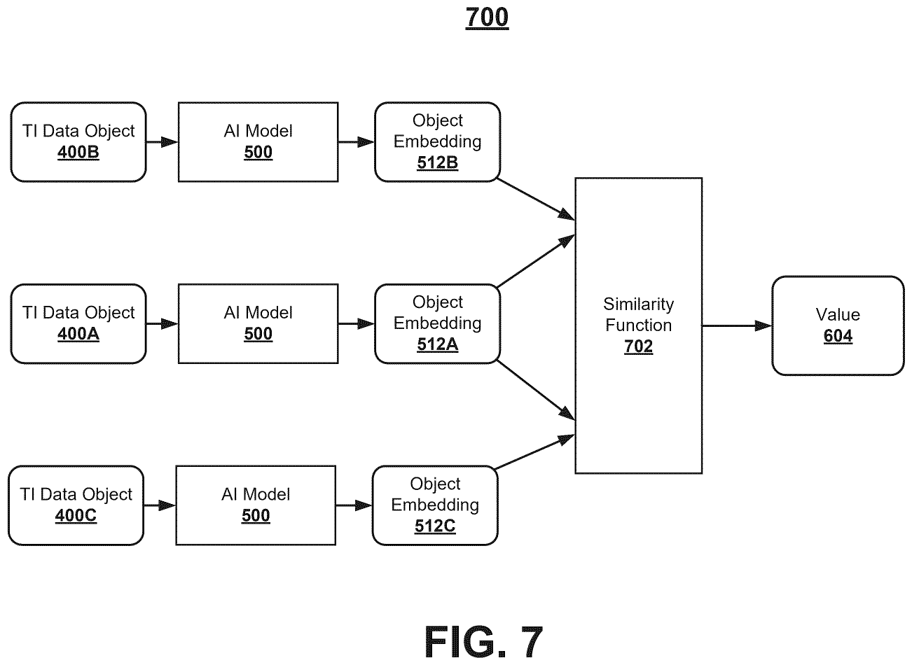

In some implementations, the similarity value reflects a degree of similarity between the first object embedding and the respective second object embedding. The degree of similarity can indicate a relevancy of the cybersecurity threat that corresponds to the respective second TI data object to the entity that corresponds to the first TI data object. In some implementations, the higher the similarity value, the more relevant the cybersecurity threat is to the entity. The respective second TI data object may be associated with the value that was calculated from that second TI data object's embedding. Further details regarding this process are discussed further below in relation to FIG. 6 and FIG. 7.

At block 340, processing logic ranks the one or more second TI data objects based on the similarity values. Each second TI data object of the one or more second TI data objects may be associated with the similarity value corresponding to the respective second TI data object's second object embedding. In one implementation, the TI manager 114 can rank the one or more second TI data objects from most relevant to least relevant. For example, where a larger similarity value reflects a larger similarity between the first object embedding and the respective second object embedding, the TI manager 114 may rank the one or more second TI data objects from highest corresponding similarity value to lowest corresponding value.

At block 350, processing logic identifies, based on the ranking of block 340, a subset of the one or more data objects. In one implementation, the subset of the one or more data objects includes a predetermined number of the second TI data objects that are most relevant to the first TI data object (as indicated by the second TI data objects' respective similarity values). In some implementations, the subset includes the second TI data objects whose corresponding similarity values exceed or fall below a threshold value. The threshold value may include a similarity value provided by or based on user input.

In some implementations, processing logic further causes display of a TI user interface of a security platform 110. The TI user interface may include a visualization based on the subset of second TI data objects identified in block 350. In one implementation, the application 132 of the client device 130 displays the TI user interface. The visualization may include the subset of the second TI data objects, a table of the subset, a heat map, or some other visualization that can indicate a relevancy of a second TI data object to the first TI data object. The visualization may order the subset of second TI data objects from most relevant to least relevant based on the similarity value associated with each second TI data object.

In one implementation, the method 300 may further include filtering one or more of the second TI data objects identified in block 340. The filtering may be based on one or more filter criteria. A filter criterion may include a condition that defines which TI data objects can be included and which can be excluded from the subset of second TI data objects. A filter criterion may specify that a TI data object that identifies a certain value for a cybersecurity attribute will be excluded from the subset. For example, a filter criterion may exclude a TI data object that includes an operating location cybersecurity attribute that identifies “Southeast Asia.” A filter criterion may specify that only TI data objects that identify a certain value for a cybersecurity attribute will be included in the subset. For example, a filter criterion may include TI data objects that include a targeted industries cybersecurity attribute that identifies “Healthcare.”

In some implementations, a TI data object may include a cybersecurity attribute that identifies a date. A filter criterion can include or exclude the TI data object responsive to the date being within a certain range. For example, a threat actor TI data object may include a last active date cybersecurity attribute that identifies the date the threat actor was last active. A filter criterion may exclude the threat actor TI data object from the subset responsive to the last active date being older than a date specified by the filter criterion. In another example, a cybersecurity report TI data object may include a publish date that identifies the date the cybersecurity report was published. A filter criterion may exclude the cybersecurity TI data object from the subset responsive to the publish date being older than a date specified by the filter criterion. In another example, a malware TI data object may include a release date that identifies the date the malware was released or discovered. A filter criterion may exclude the malware TI data object from the subset responsive to the release date being older than a date specified by the filter criterion. The filter criteria may include other criteria used to include TI data objects in or exclude TI data objects from the one or more second TI data objects. In one implementation, the filter criteria can be indicated by a user of the security platform 110. The user may indicate the filter criteria using the TI user interface of the application 132.

FIG. 4 depicts an example TI data object 400, in accordance with some implementations of the present disclosure. The TI data object 400 may represent a cybersecurity entity. The TI data object 400 may include a data structure that stores information about the corresponding entity. For example, as seen in FIG. 4, the TI data object 400 may include a JavaScript Object Notation (JSON) data object. In other examples, the TI data object 400 may include data in Extensible Markup Language (XML) format or some other data storage format. In some implementations, the TI data object 400 may include one or more

cybersecurity attributes 402A-J. A cybersecurity attribute 402A-J may include a piece of information about the corresponding entity. A cybersecurity attribute 402A-J may include a key and one or more corresponding values. The key may include data indicating a category data, and the one or more corresponding values may include data that belongs to the category.

The example TI data object 400 depicted in FIG. 4 includes multiple cybersecurity attributes 402A-J. For example, the cybersecurity attribute 402A may include an identifier that uniquely identifies the TI data object 400 among the TI data objects 400 stored by the system 100. The cybersecurity attribute 402B may include one or more names of the entity corresponding to the TI data object 400. The cybersecurity attribute 402C may include one or more industries associated with the corresponding entity. The cybersecurity attribute 402D may include one or more operating locations of the entity. The cybersecurity attribute 402E may include one or more source locations of the entity. The cybersecurity attribute 402F may include one or more vulnerabilities. The cybersecurity attribute 402G may include one or more motivations. The cybersecurity attribute 402H may include an indication as to whether the corresponding entity utilizes a wide distribution approach to achieve its goals. The cybersecurity attribute 402I may include an indication as to whether the corresponding entity utilizes ransomware. The cybersecurity attribute 402J may include one or more malware families. The TI data object 400 may include other cybersecurity attributes 402 not depicted in FIG. 4. For example, a cybersecurity attribute 402 may include a TTP or an attack surface.

FIG. 5 depicts an example AI model 500 for AI-based cybersecurity threat intelligence, in accordance with some implementations of the present disclosure. The AI model 500 may include an AI model 232 of the AI subsystem 116. As can be seen from FIG. 5, the AI model 500 can use a TI data object 400 as input, and the AI model 500 can generate an object embedding 512 based on the TI data object 400.

In one implementation, the TI data object 400 may include one or more values 502A-N. The values 502A-N may include values of the cybersecurity attributes 402A-N of the TI data object 400. For example, as seen in FIG. 5, the TI data object 400 may include industry values 502C of an industries cybersecurity attribute 402C, operating locations values 502D of an operating locations cybersecurity attribute 402D, and so on. Each set of values 502A-N can be input into an embedding sub-model 504A-N.

In one or more implementations, the AI model 500 inputs each set of values 502A-N into an embedding sub-model 504A-N. The embedding sub-model 504A-N may include an AI model 232 trained and configured to generate an intermediate embedding 506A-N for a cybersecurity attribute. Each cybersecurity attribute may be associated with a respective embedding sub-model 504A-N. An intermediate embedding 506A-N may include an embedding that is not the object embedding 512 output by the AI model 500 but is used by the AI model 500 in an intermediate step to generate the object embedding 512. The embedding sub-model 504A-N can be trained and configured such that the embedding sub-model 504A-N generates similar intermediate embeddings for similar input data.

In some implementations, the AI model 500 combined the intermediate embeddings 506A-N to form a combined embedding 508. Combining the intermediate embeddings 506A-N may include concatenating the intermediate embeddings 506A-N or combining the intermediate embeddings 506A-N in some other way. The AI model 500 can input the combined embedding 508 into an AI sub-model 510. The AI sub-model 510 may include an AI model 232 trained and configured to generate the object embedding 512. The AI sub-model 510 can be trained and configured such that the AI sub-model 510 generates similar object embeddings 512 for similar combined embeddings 508. The object embedding 512 can then be used as input to a similarity function as discussed above in relation to block 330 of the method 300 and as discussed below in relation to FIG. 6 and FIG. 7.

In some implementations, the TI subsystem 112 may train the AI sub-model 510 of the AI model 500 using an unsupervised learning process. The unsupervised learning process may include adjusting the AI sub-model 510 based on feedback data of a user of the security platform 110. The feedback data of the user may include a relevance value associated with a relationship between the first TI data object 400 and a second TI data object 400. The TI subsystem 112 may obtain the feedback data from a user of the TI subsystem 112 (e.g., from a TI user interface of the TI subsystem 112). The feedback data may include the TI subsystem 112 obtaining an indication that the user has engaged with a portion of a TI user interface of the security platform 110 that represents the second TI data object 400.

As an example, the first TI data object 400 may include a TI data object that represents a business entity, and the user may belong to the business entity. As discussed above in relation to block 350 of the method 300, the client device 130 of the user may display a TI user interface that includes a visualization based on, among other TI data objects 400, a second TI data object 400. The second TI data object 400 may represent a threat actor. The user may engage with the portion of the TI user interface that corresponds to the second TI data object 400 by clicking on the portion of the visualization that corresponds to the second TI data object 400. In response, the TI user interface may display further information about the corresponding threat actor (which may include one or more of the cybersecurity attributes 402 of the second TI data object 400). The TI user interface may include a user interface element that allows the user to provide a relevance value regarding the relevancy of the threat actor to the business entity. The relevance value may include a binary value (e.g., representing “relevant” or “not relevant”) or some other value (e.g., a value on a scale from 1 to 5 where 1 is not relevant and 5 is very relevant). The client device 130 may provide the TI manager 114 with feedback data that includes the relevance value or an indication that the user engaged with the TI user interface representation of TI data object 400 that represents the threat actor.

The TI manager 114 may receive the feedback data and may cause the AI subsystem 116 to adjust the AI sub-model 510 based on the received feedback data. For example, responsive to the feedback data indicating that the threat actor is relevant to the business entity, the training subsystem 210 may adjust the AI sub-model 510 to generate second object embeddings 512 that are more similar to the first object embedding when the AI sub-model 510 receives input TI data objects 400 that are similar to the first TI data object 400. Conversely, responsive to the feedback data indicating that the threat actor is not relevant to the business entity, the training subsystem 210 may adjust the AI sub-model 510 to generate second object embeddings 512 that are less similar to the first object embedding when the AI sub-model 510 receives input TI data objects 400 that are similar to the first TI data object 400.

FIG. 6 depicts an example dataflow 600 for AI-based cybersecurity threat intelligence, in accordance with some implementations of the present disclosure. The TI manager 114 can conduct the dataflow 600. As part of the dataflow 600, the TI manager 114 can input a first TI data object 400A into the AI model 500 to generate a first object embedding 512A, as was shown in FIG. 5. The TI manager 114 can input a second TI data object 400B into the AI model 500 to generate a second object embedding 512B.

In some implementations, the TI manager 114 inputs the first object embedding 512A and the second object embedding 512B into a similarity function 602. The similarity function 602 may include an operation, algorithm, or the like that uses multiple object embeddings 512 as input and generates a similarity value 604 based on the inputs. As discussed above, the similarity value 604 can indicate a similarity between a first object embedding 512A and a second object embedding 512B, which can indicate a relevancy of the cybersecurity threat that corresponds to the respective second TI data object 400B (from which the respective second object embedding 512B was generated) to the entity that corresponds to the first TI data object 400A (from which the first object embedding 512A was generated). In some implementations, the similarity function 602 calculates a cosine distance between the first object embedding 512A and the second object embedding 512B. In one or more implementations, the similarity function 602 calculates another type of distance between the object embeddings 512A-B (e.g., Euclidian distance, dot product, etc.).

FIG. 7 depicts another example dataflow 700 for AI-based cybersecurity threat intelligence, in accordance with some implementations of the present disclosure. Similar to the dataflow 600 of FIG. 6, as part of the dataflow 700 of FIG. 7, the TI manager 114 can input a first TI data object 400A into the AI model 500 to generate a first object embedding 512A and can input a second TI data object 400B into the AI model 500 to generate a second object embedding 512B.

In one implementation, as part of the dataflow 700, generating the similarity value 604 reflecting a similarity between the first object embedding 512A and the second object embedding 512B can be further based on the third object embedding 512C. The third object embedding 512C may include an object embedding 512 generated using the AI model 500 and can be based on a third TI data object 400C. The third TI data object 400C may correspond to a cybersecurity threat. A similarity function 702 can calculate a similarity value 604 that indicates a similarity between the first object embedding 512A and the second object embedding 512B. The similarity function 702 can differ from the similarity function 602 of FIG. 6 because the similarity function 702 accepts three object embeddings 512A-C as input. The similarity function 702 can calculate a first cosine distance between the first object embedding 512A and the second object embedding 512B and a second cosine distance between the first object embedding 512A and the third object embedding 512C. The similarity function 702 can perform a pairwise comparison between the first, second, and third object embeddings 512A-C.

In one implementation, the TI manager 114 may select the third TI data object 400C based on a TI knowledge graph, which may be stored in the data store 120. The TI knowledge graph may include a data structure that stores data reflecting relationships between TI data objects 400. The knowledge graph may include a graph where the nodes correspond to the TI data objects 400 and each edge indicates a relationship between two TI data objects 400 that are represented by the two nodes connected by the edge. In some implementations, the graph is a directed graph where the edges are directed edges (i.e., one-way edges).

For example, an edge from a threat actor TI data object 400 to a piece of malware TI data object 400 may indicate that the corresponding threat actor has used that corresponding piece of malware. An edge from a threat actor TI data object 400 to a cybersecurity report TI data object 400 may indicate that the corresponding threat actor was referenced in the corresponding cybersecurity report. An edge from a piece of malware TI data object 400 to a cybersecurity report TI data object 400 may indicate that the corresponding piece of malware was referenced in the corresponding cybersecurity report. An edge from a cyberattack campaign TI data object 400 to a threat actor TI data object 400 may indicate that the corresponding cyberattack campaign was carried out by the corresponding threat actor. An edge from a cyberattack campaign TI data object 400 to a piece of malware TI data object 400 may indicate that the corresponding cyberattack campaign included use of the corresponding piece of malware. Other types of relationships may be indicated by edges between different types of TI data objects 400. In some implementations, the TI manager 114 may select, as the third TI data object 400C, a TI data object 400 that does not have an edge leading to the second TI data object 400B in the TI knowledge graph. Selecting TI data objects 400 that are not connected in the TI knowledge graph as the second and third TI data objects 400B-C in the dataflow 700 may assist the similarity function 702 in generating more semantically meaningful similarity values 604.

As discussed above, the training data engine 212 can obtain and/or generate training data for the AI models 230A-M (which may include an embedding sub-models 504A-N, an AI sub-model 510, an AI model 500, or other AI models utilized in the present disclosure), and the training engine 214 can train the AI models 230A-M using the training data. In one implementation, a piece of training data includes two TI data objects 400 and a label indicating whether the two TI data objects 400 are similar. The label indicating whether the two TI data objects 400 are similar may include a binary value (e.g., “0” indicating dissimilar, “1” indicating similar) or a value indicating a degree of similarity (e.g., a value between 0 and 1 where values closer to “0” indicate a higher degree of similarity and values closer to “1” indicate a higher degree of dissimilarity). The training engine 214 can use the training data to train an AI model 230A-N. In one example, the training engine 214 may obtain a piece of training data, use the two TI data objects 400 of the piece of training data as the TI data objects 400A-B in the dataflow 600 of FIG. 6, and cause the AI model 500 to generate the object embeddings 512A-B based on the TI data objects 400A-B. The training engine 214 may input the object embeddings 512A-B into a loss function. A loss function may include an operation, algorithm, or the like that uses the object embeddings 512A-B as input and outputs a loss function value that indicates a degree of similarity between the input object embeddings 512A-B. For example, a loss function may include a contrastive loss function that calculates a cosine distance between the first object embedding 512A and the second object embedding 512B. The training engine 214 may then compare the loss function value to the label of the piece of training data and cause the AI model 500 to adjust one or more weights of the AI model 500 based on whether the loss function value aligns with the piece of training data's label. Adjusting the one or more weights may include adjusting the weights in manner that causes the AI model's 500 output object embeddings 512A-B to minimize the loss function value such that similarity values 604 for similar TI data objects 400 are maximized and similarity values 604 for dissimilar TI data objects 400 are minimized, subject to relevant constraints.

In another example, a piece of training data may include three TI data objects 400. The piece of training data may include a label indicating that a first and second TI data objects of the three TI data objects 400 are similar and that the first and third TI data objects 400 are dissimilar. The training data engine 212 may obtain the piece of training data, use the three TI data objects 400 of the piece of training data as the TI data objects 400A-C in the dataflow 700 of FIG. 7, and cause the AI model 500 to generate the object embeddings 512A-C based on the TI data objects 400A-C. The training engine 214 may input the object embeddings 512A-C into a loss function. The loss function may include a triplet loss function that calculates a first cosine distance between the first object embedding 512A and a second object embedding 512B and a second cosine distance between the first object embedding 512A and the third object embedding 512C. The training engine 214 may then compare the output loss function values to the label of the piece of training data and cause the AI model 500 to adjust one or more weights of the AI model 500 based on whether the loss function values align with the piece of training data's label. Adjusting the one or more weights may include adjusting the weights in manner that causes the AI model's 500 output object embeddings 512A-C to minimize the loss function value such that the similarity value 604 for similar TI data objects 400A-B are maximized and the similarity value 604 for dissimilar TI data objects 400A-C are minimized, subject to relevant constraints.

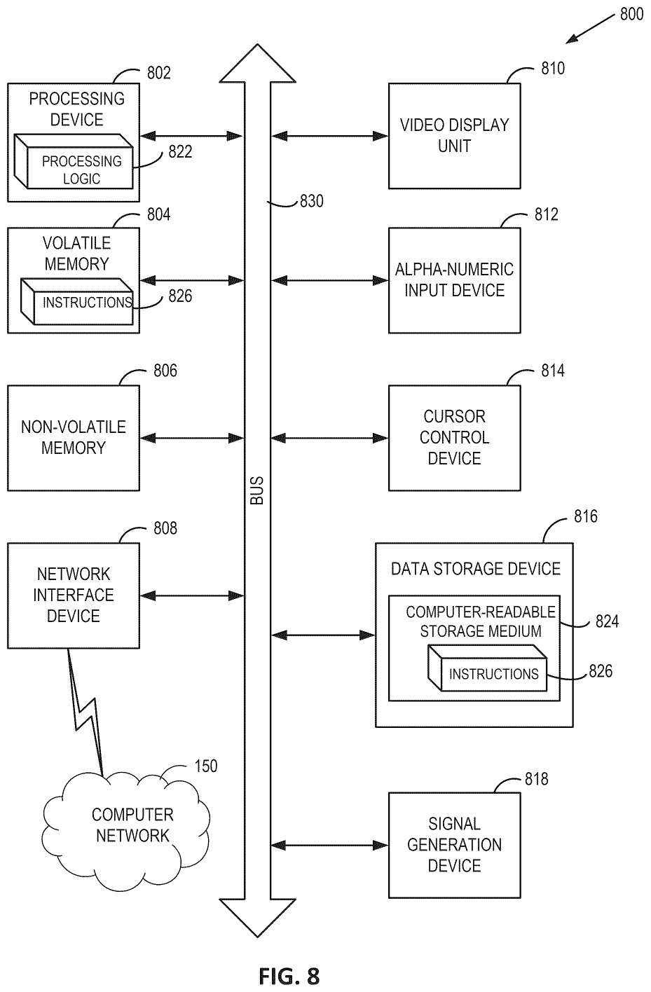

FIG. 8 is a block diagram illustrating an example computer system 800, in accordance with implementations of the present disclosure. The computer system can be a computing device or other device discussed herein. The computer system 800 can be the security platform 110, TI subsystem 112, TI manager 114, client device 130, or external computing device 140 of FIG. 1. The computer system 800 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a volatile memory 804 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 806 (e.g., flash memory, static random access memory (SRAM), etc.), and a data storage device 816, which communicate with each other via a bus 830.

The processing device 802 represents one or more general-purpose processing devices such as a microprocessor, CPU, GPU, or the like. More particularly, the processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an ASIC, a field programmable gate array (FPGA), a digital signal processor (DSP), network processor, or the like. The processing device 802 is configured to execute instructions 826 (e.g., for performing the method 300) for performing the operations discussed herein.

The computer system 800 can further include a network interface device 808. The network interface device 808 can assist in data communication between computing devices. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a non-transitory machine-readable storage medium 824 (also computer-readable storage medium) on which is stored one or more sets of instructions 826. The instructions may embody any one or more of the methodologies or functions described herein. The instructions 826 can also reside, completely or at least partially, within the volatile memory 804 and/or within the processing device 802 during execution thereof by the computer system 800, the volatile memory 804 and the processing device 802 also constituting machine-readable storage media. The instructions 826 can further be transmitted or received over the computer network 150 via the network interface device 808.

In one implementation, the instructions 826 include instructions for AI-based cybersecurity threat intelligence. While the computer-readable storage medium 824 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “generating,” “obtaining,” “identifying,” “causing,” “combining,” “training,” “providing,” “engaging,” or the like, may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the method 300 is depicted and described herein as a series of acts. However, acts in accordance with this disclosure can occur in various orders and/or concurrently, and with other acts not presented and described herein. Furthermore, not all illustrated acts can be required to implement the method in accordance with the disclosed subject matter. In addition, those skilled in the art will understand and appreciate that the method could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus can be constructed for the intended purposes, or it can comprise a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation,” “an implementation,” “some implementations,” “one embodiment,” “an embodiment,” or “some embodiments” mean that a particular feature, structure, or characteristic described in connection with the implementation or embodiment is included in at least one implementation or embodiment. Thus, the appearances of the phrase “in one implementation” or “in an implementation” or other similar terms in various places throughout this specification are not necessarily all referring to the same implementation. In addition, the term “or” is intended to mean an inclusive “or” rather than an exclusive “or.” Moreover, the word “example” or a similar term are used herein to mean serving as an example, instance, or illustration. Any aspect or design described herein as an “example” is not necessarily to be construed as preferred or advantageous over other aspects or designs. Rather, use of the word “example” or a similar term is intended to present concepts in a concrete fashion.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
generating, using an artificial intelligence (AI) model, a first object embedding of a first threat intelligence (TI) data object, wherein the first TI data object comprises first one or more cybersecurity attributes of a business entity;
obtaining a plurality of second object embeddings, wherein:
each second object embedding represents a respective second TI data object, and
the respective second TI data object includes second one or more cybersecurity attributes of a cybersecurity threat;
for each second object embedding, generating a respective similarity value reflecting a similarity between the first object embedding and the respective second object embedding;
ranking, based on the similarity values, the plurality of second TI data objects; and
identifying, based on the ranking, a subset of the plurality of the second TI data objects that are relevant to the first TI data object.

2. The method of claim 1, wherein using the AI model comprises:
for each cybersecurity attribute of the first one or more cybersecurity attributes, generating, using an embedding sub-model, an intermediate embedding;
combining the intermediate embeddings; and
generating, using a trained AI sub-model and based on the combined intermediate embeddings, the first object embedding.

3. The method of claim 1, wherein:
a second TI data object of the plurality of second TI data objects corresponds to a threat actor; and
the second one or more cybersecurity attributes identify at least one of an industry targeted by the threat actor, or a location targeted by the threat actor.

4. The method of claim 3, wherein the second one or more cybersecurity attributes further comprises at least one of a motivation of the threat actor, or an indication of whether the threat actor utilizes ransomware.

5. The method of claim 1, wherein a second TI data object of the plurality of second TI data objects corresponds to:
a threat actor;
a cybersecurity vulnerability;
a malware family; or
a cybersecurity report.

6. The method of claim 1, wherein generating the respective similarity value comprises calculating a cosine similarity between the first object embedding and a respective second object embedding of the plurality of second object embeddings.

7. The method of claim 1, further comprising training an AI sub-model of the AI model using an unsupervised learning process, wherein the unsupervised learning process comprises adjusting the AI sub-model based on a feedback action of a user of a security platform.

8. The method of claim 7, wherein the feedback action of the user comprises at least one of:
providing, to the security platform, a relevance value associated with a relationship between the first TI data object and the second TI data object; or
the user engaging with a portion of a TI user interface of the security platform that corresponds to the second TI data object.

9. A system, comprising:
a memory; and
a processing device, coupled to the memory, configured to perform operations comprising:
generating, using an artificial intelligence (AI) model, a first object embedding of a first threat intelligence (TI) data object, wherein the first TI data object comprises first one or more cybersecurity attributes of a business entity;
obtaining a plurality of second object embeddings, wherein:
each second object embedding represents a respective second TI data object, and
the respective second TI data object includes second one or more cybersecurity attributes of a cybersecurity threat;
for each second object embedding, generating a respective similarity value reflecting a similarity between the first object embedding and the respective second object embedding;
ranking, based on the similarity values, a plurality of second TI data objects; and
identifying, based on the ranking, a subset of the plurality of second TI data objects that are relevant to the first TI data object.

10. The system of claim 9, wherein the first one or more cybersecurity attributes of the business entity identify at least one of an industry in which the business entity operates, or an operating location of the business entity.

11. The system of claim 9, wherein the first one or more cybersecurity attributes of the business entity identify attack surface information of the business entity.

12. The system of claim 9, wherein:
a second TI data object of the plurality of second TI data objects corresponds to a cybersecurity vulnerability; and
the second one or more cybersecurity attributes identifies an operating system impacted by the cybersecurity vulnerability.

13. The system of claim 9, wherein:
generating the respective similarity value is further based on a third object embedding;
the third object embedding represents a third TI data object; and
the generating the respective similarity value comprises calculating a first cosine distance between the first object embedding and the respective second object embedding and a second cosine distance between the first object embedding and the third object embedding.

14. The system of claim 9, wherein using the AI model comprises:
for each cybersecurity attribute of the first one or more cybersecurity attributes, generating, using an embedding sub-model, an intermediate embedding;
combining the intermediate embeddings; and
generating, using a trained AI sub-model and based on the combined intermediate embeddings, the first object embedding.

15. The system of claim 14, wherein the trained AI sub-model comprises an artificial neural network.

16. The system of claim 14, wherein the trained AI sub-model comprises a transformer.

17. A non-transitory computer-readable storage medium comprising instructions that, when executed by a processing device, cause the processing device to:
generating, using an artificial intelligence (AI) model, a first object embedding of a first threat intelligence (TI) data object, wherein the first TI data object comprises first one or more cybersecurity attributes of a first cybersecurity threat;
obtaining a plurality of second object embeddings, wherein:
each second object embedding represents a respective second TI data object, and
the respective second TI data object includes second one or more cybersecurity attributes of a second cybersecurity threat;
for each second object embedding, generating a respective similarity value reflecting a similarity between the first object embedding and the respective second object embedding;
ranking, based on the similarity values, the plurality of second TI data objects; and
identifying, based on the ranking, a subset of the plurality of the second TI data objects that are relevant to the first TI data object.

18. The computer-readable storage medium of claim 17, wherein the first TI data object corresponds to at least one of a cybersecurity alert, or a cyberattack campaign.

19. The computer-readable storage medium of claim 17, wherein:
the first TI data object corresponds to a threat actor; and
a second TI data object of the plurality of second TI data objects corresponds to a cybersecurity report.

20. The computer-readable storage medium of claim 17, wherein the instructions further cause the processing device to filter the subset of the plurality of second TI data objects based on one or more filter criterion indicated by a user of a security platform.
